(19) United States
(12) Patent Application Publication
(10) Pub. No.: US 2024/0425729 A1
(43) Pub. Date: Dec. 26, 2024

(54) Cure accelerator for anaerobic curable composition

(71) Applicant: Henkel AG & Co. KGaA, Duesseldorf (DE)

(72) Inventors: Nishant Tale, Pune (IN); Namdev Ghule, Navi Mumbai (IN); Rakhi Dhuriya, Maharashtra (IN); Prasad Khandagale, Maharashtra (IN); David Condron, Dublin (IE); Jayesh P Shah, Pune (IN)

(21) Appl. No.: 18/821,114

(22) Filed: Aug. 30, 2024

Related U.S. Application Data
(63) Continuation of application No. PCT/EP2023/054325, filed on Feb. 21, 2023.

(30) Foreign Application Priority Data
Mar. 4, 2022 (IN) 202241011747

(51) Int. Cl. C09J 135/02; C08F 122/10; C08K 5/08; C08K 5/17; C08K 5/18; C09J 11/06

(52) U.S. Cl. CPC C09J 135/02; C08F 122/1006; C08K 5/08; C08K 5/175; C08K 5/18; C09J 11/06

(57) ABSTRACT

The present invention relates to an anaerobic curable composition comprising a) a (meth) acrylate component; b) a first curing agent; c) a second curing agent; and d) a cure accelerator comprising 2-(N-ethylanilino) ethanol and/or 1,2,3,4-tetrahydro benzo(H) quinoline-3-ol. The anaerobic curable composition according to present invention can be used in adhesives, sealants, thread lockers and retainers.

### FIELD OF THE INVENTION

The present invention relates to an anaerobic curable (meth)acrylate composition having improved sustainability, health, and safety profile.

### TECHNICAL BACKGROUND

Anaerobic technology is most widely used in the appliance industry, since the technology offers enhancement in equipment reliability, time saving, cost reduction, and improves process safety. Anaerobic adhesives are one component (1 k) systems which comprise esters of acrylic or methacrylic acid and are cured by a redox initiated free radical mechanism driven by an accelerator and an initiator. The word anaerobic indicates the polymerization takes place in absence of air. Typical anaerobic adhesives comprise (meth)acrylate monomers and/or (meth)acrylate oligomers, stabilizers, form modifiers and curatives such as amines, peroxides, and saccharin.

Cumene hydroperoxide is extensively used curing agent in anaerobic products because of its properties such as self-accelerating decomposition temperature (SADT) 70° C. and maximum storage temperature 40° C. (Ts max). However, its safety labelling is a category 2 carcinogen due the nature of the compound and cumene impurity present. Similarly, diethyl-p-toluidine (DE-p-T) and dimethyl-o-toluidine (DM-o-T) which are used often and are among the most effective cure accelerators in terms of a cure speed and strength development of the composition, have a poor health and safety profile.

There have been some attempts to replace diethyl-p-toluidine (DE-p-T) and dimethyl-o-toluidine (DM-o-T) in the aerobically curable compositions. However, the peroxide component, such as cumene hydroperoxide was still present in the composition, and therefore, the problems in the health and safety profile were not completely fixed.

Therefore, there is a need for an anaerobically curable composition which can provide improved sustainability, health, and safety profile without losing the technical performance of the adhesive composition.

### SUMMARY OF THE INVENTION

The present invention relates to an anaerobic curable composition comprising a) a (meth) acrylate component; b) a first curing agent; c) a second curing agent; and d) a cure accelerator comprising 2-(N-ethylanilino)ethanol and/or 1,2,3,4-tetrahydro benzo(H) quinoline-3-ol.

The present invention also relates to a cured product of the anaerobic curable composition according to the present invention.

The present invention encompasses use of an anaerobic curable composition or a cured product according to the present invention in adhesives, sealants, thread lockers and retainers.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

As used herein, the term “consisting of” excludes any element, ingredient, member or method step not specified.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skilled in the art to which this invention belongs to. By means of further guidance, term definitions are included to better appreciate the teaching of the present invention.

The present invention relates to an anaerobic curable composition comprising a) a (meth) acrylate component; b) a first curing agent; c) a second curing agent; and d) a cure accelerator comprising 2-(N-ethylanilino)ethanol and/or 1,2,3,4-tetrahydro benzo(H) quinoline-3-ol.

The Applicant has found out that use of a cure accelerator comprising especially a combination of tert-butyl peroxy-3,5,5-trimethyl hexanoate and 2-(N-ethylanilino)ethanol and/or 1,2,3,4-tetrahydro benzo(H) quinoline-3-ol improves the sustainability, health and safety profile of the composition. Further the use of 2-(N-ethylanilino)ethanol and/or 1,2,3,4-tetrahydro benzo(H) quinoline-3-ol has enabled to lower the quantity of the first curing agent (peroxides) without losing the performance profile of the composition.

An anaerobic curable composition according to the present invention comprises a (meth) acrylate component. Suitable (meth)acrylate component may be a (meth)acrylate monomer, a (meth)acrylate oligomer or a (meth)acrylate polymer.

(Meth)acrylate monomers suitable for use as the (meth)acrylate component in the present invention may be selected from a wide variety of materials, such as those represented by H₂C=CGCO²R⁸, where G may be hydrogen, halogen or alkyl groups having from 1 to 4 carbon atoms, and R⁸ may be selected from alkyl, cycloalkyl, alkenyl, cycloalkenyl, alkaryl, aralkyl or aryl groups having from 1 to 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulphur, sulfonate, sulfone and the like.

Additional (meth)acrylate monomers suitable for use herein as the (meth)acrylate component in the present invention or as a component in making the reaction product include polyfunctional (meth)acrylate monomers, for example di- or tri-functional (meth)acrylates such as polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylates (“TMPTMA”), diethylene glycol dimethacrylate, triethylene glycol dimethacrylates (“TRIEGMA”), tetraethylene glycol di(meth)acrylates, dipropylene glycol di(meth)acrylates, di-(pentamethylene glycol) di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, and bisphenol-A mono and di(meth)acrylates, such as ethoxylated bisphenol-A (meth)acrylate (“EBIPMA”), and bisphenol-F mono and di(meth)acrylates, such as ethoxylated bisphenol-A (meth)acrylate.

Still other (meth)acrylate monomers that may be used herein include silicone (meth)acrylate moieties (“SiMA”), such as those disclosed in U.S. Pat. No. 5,605,999.

Other suitable monomers include polyacrylate esters represented by the formula:

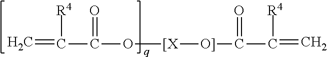

where R⁴ is a radical selected from hydrogen, halogen or alkyl of from 1 to 4 carbon atoms; q is an integer equal to at least 1, and preferably equal to from 1 to 4; and X is an organic radical containing at least two carbon atoms and having a total bonding capacity of q plus 1. With regard to the upper limit for the number of carbon atoms in X, workable monomers exist at essentially any value. As a practical matter, however, a general upper limit is 50 carbon atoms, preferably 30, and most preferably 20.

For example, X can be an organic radical of the formula:

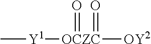

wherein each of Y1 and Y2 is an organic radical, preferably a hydrocarbon group, containing at least 2 carbon atoms, and preferably from 2 to 10 carbon atoms, and Z is an organic radical, preferably a hydrocarbon group, containing at least 1 carbon atom, and preferably from 2 to 10 carbon atoms.

Other classes of useful monomers are the reaction products of di- or tri-alkylolamines (e.g., ethanolamines or propanolamines) with acrylic acids, such as are disclosed in French Patent No. 1,581,361.

Examples of useful acrylate ester oligomers include those having the following general formula:

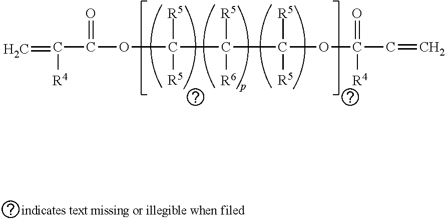

where R⁵ represents a radical selected from hydrogen, lower alkyl of from 1 to 4 carbon atoms, hydroxy alkyl of from 1 to 4 carbon atoms, and

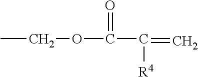

where R⁴ is a radical selected from hydrogen, halogen, or lower alkyl of from 1 to about 4 carbon atoms; R⁶ is a radical selected from hydrogen, hydroxyl,

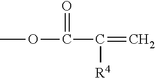

or m is an integer equal to at least 1, e.g., from 1 to 15 or higher, and preferably from 1 to 8; n is an integer equal to at least 1, e.g., 1 to 40 or more, and preferably between 2 and 10; and p is 0 or 1.

Typical examples of acrylate ester oligomers corresponding to the above general formula include di-, tri- and tetraethyleneglycol dimethacrylate; di(pentamethyleneglycol)dimethacrylate; tetraethyleneglycol diacrylate; tetraethyleneglycol di(chloroacrylate); diglycerol diacrylate; diglycerol tetramethacrylate; butyleneglycol dimethacrylate; neopentylglycol diacrylate; and trimethylolpropane triacrylate.

While di- and other polyacrylate esters, and particularly the polyacrylate esters described in the preceding paragraphs, can be desirable, monofunctional acrylate esters (esters containing one acrylate group) also may be used. When dealing with monofunctional acrylate esters, it is highly preferable to use an ester which has a relatively polar alcoholic moiety. Such materials are less volatile than low molecular weight alkyl esters and, more important, the polar group tends to provide intermolecular attraction during and after cure, thus producing more desirable cure properties, as well as a more durable sealant or adhesive. Desirably, the polar group is selected from labile hydrogen, heterocyclic ring, hydroxy, amino, cyano, and halo polar groups. Typical examples of compounds within this category are cyclohexylmethacrylate, tetrahydrofurfuryl methacrylate, hydroxyethyl acrylate, hydroxypropyl methacrylate, t-butylaminoethyl methacrylate, cyanoethylacrylate, and chloroethyl methacrylate.

Another useful class of monomers is prepared by the reaction of a monofunctionally substituted alkyl or aryl acrylate ester containing an active hydrogen atom on the functional substituent. This monofunctional, acrylate-terminated material is reacted with an organic polyisocyanate in suitable proportions so as to convert all of the isocyanate groups to urethane or ureido groups. The monofunctional alkyl and aryl acrylate esters are preferably the acrylates and methacrylates containing hydroxy or amino functional groups on the non-acrylate portion thereof. Acrylate esters suitable for use have the formula:

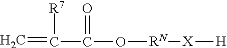

where X is selected from —O— or

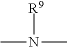

and R⁹ is selected from hydrogen or lower alkyl of 1 through 7 carbon atoms; R⁷ is selected from hydrogen, chlorine or methyl and ethyl radicals; and R⁸ is a divalent organic radical selected from lower alkylene of 1 through 8 carbon atoms, phenylene or naphthylene. These groups upon proper reaction with a polyisocyanate, yield a monomer of the following general formula:

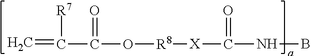

where n is an integer from 2 to 6; B is a polyvalent organic radical selected from alkyl, alkenyl, cycloalkyl, cycloalkenyl, aryl, aralkyl, alkaryl or heterocyclic radicals both substituted and unsubstituted; and R⁷, R⁸ and X have the meanings given above.

Examples of suitable hydroxyl-functional (meth)acrylate include hydroxyethyl acrylate, hydroxypropyl acrylate, hydroxybutyl acrylate, hydroxyethyl methacrylate (“HEMA”), hydroxypropyl methacrylate (“HPMA”), hydroxybutyl methacrylate and mixtures thereof. Other examples of suitable hydroxy functional (meth)acrylates include 2-hydroxyethyl acrylate, 2-hydroxypropyl acrylate, 2-hydroxyethyl methacrylate (“HEMA”), pentaerythritol triacrylate (“PETA”), and 4-hydroxybutyl acrylate.

The hydroxy-functional (meth)acrylate can have a number average molecular weight of about 80 to about 1,000 grams/mole, or about 100 to about 800 grams/mole, or about 110 to about 600 grams/mole.

Of course, combinations of these (meth)acrylate components may also be used.

In a highly preferred embodiment, the (meth)acrylate component is selected from the group consisting of hydroxyethyl methacrylate, hydroxypropyl methacrylate, poly(ethylglycol) dimethacrylate, and mixtures thereof.

Suitable commercially available (meth)acrylate components for use in the present invention include but are not limited to hydroxyethyl methacrylate and hydroxypropyl methacrylate from Geo Specialty and Sartomer.

An anaerobic curable composition according to the present invention, may have the (meth)acrylate component present from 87 to 97% by weight of the total weight of the composition, preferably from 89 to 97% and more preferably from 90 to 96.5%.

The above defined quantity range is ideal, and it provides good strength for the anaerobic curable composition according to the present invention. Quantities less than 87% and more than 97% may have direct, negative impact to the strength of the anaerobic curable composition.

An anaerobic curable composition according to the present invention comprises a first curing agent. The first curing agent may be a hydroperoxide, preferably selected from the group consisting t-butyl hydroperoxide, p-methane hydroperoxide, tert-butyl perbenzoate, diisopropylbenzene hydroperoxide, tert-butyl peroxy-3,5,5-trimethylhexanoate, diacetyl peroxide, benzoyl peroxide, tert-butyl peracetate, lauryl peroxide, tert-butyl peroxybenzoate, tert-butylperoxy-2-ethylhexyl carbonate, tert-amyl hydroperoxide, 1,1,3,3-tetramethyl butyl hydroperoxide, and mixtures thereof, more preferably selected from the group consisting of p-methane hydroperoxide, diisopropylbenzene hydroperoxide, tert-butyl peroxy-3,5,5-trimethylhexanoate, tert-butyl peracetate, lauryl peroxide, tert-butylperoxy-2-ethylhexyl carbonate, tert-amyl hydroperoxide, 1,1,3,3-tetramethyl butyl hydroperoxide, and mixtures thereof, and even more preferably the first curing agent is tert-butyl peroxy-3,5,5-trimethylhexanoate.

In a highly preferred embodiment, the first curing agent is tert-butyl peroxy-3,5,5-trimethylhexanoate. Tert-butyl peroxy-3,5,5-trimethylhexanoate is particularly preferred, because it may provide improved health and safety profile and shows similar cure performance at a lower quantity.

Suitable commercially available first curing agents for use in the present invention include but are not limited to p-methane hydroperoxide from MPI Chemie, tert-butyl perbenzoate from Nouryon, benzoyl peroxide from Akzo Nobel, and tert-butyl peroxy-3,5,5-trimethylhexanoate from Arkema.

An anaerobic curable composition according to the present invention may have the first curing agent present from 0.1 to 3.0% by weight of the total weight of the composition, preferably from 0.15 to 2.5% and more preferably from 0.2 to 2.3%.

The above ranges are preferred because they provide good cure profile to the composition according to the present invention. When the quantity of the first curing agent is less than 0.1% this may lead to a slow cure rate and the strength performance of the composition may be negatively affected. Whereas high quantities, more than 3%, may lead to a fast cure rate and instability of the composition.

An anaerobic curable composition according to the present invention comprises a second curing agent. The second curing agent is preferably selected from the group consisting of saccharin, di-p-toluylsulfonimide, tert-butylbezoyl toluylsulfonamide, methylbenzoyl toluylsulfonamide, methoxybenzoyl toluylsulfonamide, and mixtures thereof, more preferably the second curing agent is saccharin.

In a highly preferred embodiment, the second curing agent is saccharin. Saccharin is particularly preferred, as it may act also as a co-accelerator in the composition.

Suitable commercially available second curing agents for use in the present invention include but are not limited to saccharin, di-p-toluylsulfonimide, and tert-butylbezoyl toluylsulfonamide from Univar.

An anaerobic curable composition according to the present invention may have the second curing agent present from 0.1 to 5.0% by weight of the total weight of the composition, preferably from 1.0 to 3.5% and more preferably from 1.1 to 3.0%.

The above ranges are preferred as they provide good cure profile to the composition according to the present invention. When the quantity of the second curing agent is less than 0.1% this may lead to a slow cure rate and the strength performance of the composition may be negatively affected. Whereas high quantities, more than 5%, may lead to a fast cure rate and instability of the composition.

In another highly preferred embodiment, the anaerobic curable composition according to the present invention comprises a first curing agent, which is tert-butyl peroxy-3,5,5-trimethylhexanoate and a second curing agent, which is saccharin.

The composition according to the present invention comprises a cure accelerator comprising 2-(N-ethylanilino)ethanol and/or 1,2,3,4-tetrahydro benzo(H) quinoline-3-ol (TBHQ-ol).

2-(N-ethylanilino)ethanol and 1,2,3,4-tetrahydro benzo(H) quinoline-3-ol (TBHQ-ol) are selected and preferred because they provide better health and safety profile compared to a conventional cure accelerators while showing equal or at least comparable reactivity and stability in the composition according to the present invention.

Suitable commercially available cure accelerators for use in the present invention include but are not limited to 2-(N-ethylanilino)ethanol from BASF and 1,2,3,4-tetrahydro benzo(H) quinoline-3-ol (TBHQ-ol) from Vanamali Organics.

An anaerobic curable composition according to the present invention may have the cure accelerator present from 0.1 to 1.5% by weight of the total weight of the composition, preferably from 0.2 to 1.0% and more preferably from 0.25 to 0.75%.

The quantity of the cure accelerator is very important in order to obtain a good cure profile and composition stability, the above defined ranges are able to provide this. If the quantity of the cure accelerator is less than 0.1%, the cure rate may be too slow, whereas the quantity greater than 1.5% may have a negative impact to a stability of the composition.

An anaerobic curable composition according to the present invention may further comprise a stabilizer.

The stabilizer is preferably selected from the group consisting of benzoquinone, 1,4-naphthoquinone, anthraquinone, hydroquinone, methoxyhydroquinone, tert-butylhydroquinone butylated hydroxy toluene, and mixtures thereof, preferably the stabilizer is 1,4-naphthoquinone.

Above listed stabilizers are preferred because they are proven stabilizers and may prevent the premature polymerization of the composition i.e., they may provide required shelf-life stability for the composition according to the present invention.

Suitable commercially available stabilizer for use in the present invention include but is not limited to 1,4-naphthoquinone from Sigma Aldrich.

An anaerobic curable composition according to the present invention may have the stabilizer present from 0.01 to 1.0% by weight of the total weight of the composition, preferably from 0.05 to 0.75% and more preferably from 0.1 to 0.4%.

If the quantity of the stabilizer is less than 0.01% this may negatively affect the stability of the composition according to the present invention. Whereas quantity more than 1% may not have any significant additional impact on stability and performance of the composition.

An anaerobic curable composition according to the present invention may further comprise a chelating agent.

Preferably the chelating is selected from the group consisting of sodium salt of ethylene diamine tetraacetic acid, N-hydroxy ethylenediamine tetra acetic acid trisodium salt (HEDTA Nas), tetrakis-(2-hydroxy propyl) ethylene diamine (EDTPA), diethylenetriaminepentaacetic acid pentasodium salt (DTPA), and mixtures thereof, preferably the chelating agent is sodium salt of ethylene diamine tetraacetic acid.

Sodium salt of ethylene diamine tetraacetic acid chelating agent is preferred because it is more efficient when compared to the other ordinary chelating agents.

Suitable commercially available chelating agent for use in the present invention include but is not limited to sodium salt of ethylene diamine tetraacetic acid from BASF.

An anaerobic curable composition according to the present invention may have the chelating agent present from 0.2 to 2.0% by weight of the total weight of the composition, preferably from 0.3 to 1.5% and more preferably from 0.6 to 1.2%.

If the quantity of the chelating agent is less than 0.2%, this may negatively affect the stability of the composition. Whereas quantity more than 2.0% does not have any significant additional impact on stability and performance of the composition.

An anaerobic curable composition according to the present invention may further comprise a pigment.

Preferably the pigment is selected from the group consisting of 1-phenylazo-2-naphtol (Solvent yellow 14), 2,4-dihydro-5-methyl-2-phenyl-4-(phenylazo)-3H-pyrazol-3-one (Sudan Yellow 146) and 1,4-bis(p-tolylamino)anthraquinone (Sudan Green 4 B) and mixtures thereof.

An anaerobic curable composition according to the present invention may have the pigment present from 0.01 to 0.05% by weight of the total weight of the composition.

In a preferred embodiment an anaerobic curable composition comprising according to the present invention comprises a) a (meth) acrylate component; b) a first curing agent, wherein the first curing agent is tert-butyl peroxy-3,5,5-trimethylhexanoate; c) a second curing agent; and d) a cure accelerator comprising 2-(N-ethylanilino)ethanol and/or 1,2,3,4-tetrahydro benzo(H) quinoline-3-ol.

In a preferred embodiment an anaerobic curable composition comprising according to the present invention comprises a) a (meth) acrylate component; b) a first curing agent, wherein the first curing agent is tert-butyl peroxy-3,5,5-trimethylhexanoate; c) a second curing agent wherein the first curing agent is saccharin; and d) a cure accelerator comprising 2-(N-ethylanilino)ethanol and/or 1,2,3,4-tetrahydro benzo(H) quinoline-3-ol.

In another preferred embodiment an anaerobic curable composition comprising according to the present invention comprises a) a (meth) acrylate component; b) from 0.1 to 3.0% by weight of the total weight of the composition, preferably from 0.1 to 2.75% and more preferably from 0.1 to 2.3% of a first curing agent, wherein the first curing agent is tert-butyl peroxy-3,5,5-trimethylhexanoate; c) a second curing agent; and d) a cure accelerator comprising from 0.1 to 1.5% by weight of the total weight of the composition, preferably from 0.2 to 1.0% and more preferably from 0.25 to 0.75% of 2-(N-ethylanilino)ethanol and/or from 0.1 to 1.5% by weight of the total weight of the composition, preferably from 0.2 to 1.0% and more preferably from 0.25 to 0.75% of 1,2,3,4-tetrahydro benzo(H) quinoline-3-ol.

Yet in another preferred embodiment an anaerobic curable composition comprising according to the present invention comprises a) a (meth) acrylate component; b) from 0.1 to 3.0% by weight of the total weight of the composition, preferably from 0.1 to 2.75% and more preferably from 0.1 to 2.3% of a first curing agent, wherein the first curing agent is tert-butyl peroxy-3,5,5-trimethylhexanoate; c) a second curing agent, wherein the second curing agent is saccharin; and d) a cure accelerator comprising from 0.1 to 1.5% by weight of the total weight of the composition, preferably from 0.2 to 1.0% and more preferably from 0.25 to 0.75% of 2-(N-ethylanilino)ethanol and/or from 0.1 to 1.5% by weight of the total weight of the composition, preferably from 0.2 to 1.0% and more preferably from 0.25 to 0.75% of 1,2,3,4-tetrahydro benzo(H) quinoline-3-ol.

The present invention also relates to a cured product of the anaerobic curable composition according to the present invention.

The present invention relates to use the anaerobic curable composition according to the present invention or the cured products in adhesives, sealants, thread lockers and retainers.

### EXAMPLES

### Example 1

Four anaerobic compositions were prepared wherein the concentration of 1,2,3,4-tetrahydro benzo(H) quinoline-3-ol (THBQ-ol) was maintained at 0.5% w/w while tert-butyl peroxy-3,5,5-trimethylhexanoate (TBPTH) concentration was varied from 0.25 to 1.0% w/w. The formulations details are provided below in Table 1.

TABLE 1

| | Comparative | Example | Example | Example | Example |
|---|---|---|---|---|---|
| Ingredients | example 1 | 1 | 2 | 3 | 4 |
| PEG200DMA from | 92.43 | 95.51 | 95.26 | 95.01 | 94.76 |
| Geo Specialty, | | | | | |
| Sartomer | | | | | |
| 1,4- | 0.21 | 0.21 | 0.21 | 0.21 | 0.21 |
| naphthoquinone | | | | | |
| from Sigma Aldrich | | | | | |
| sodium salt of | 0.88 | 0.88 | 0.88 | 0.88 | 0.88 |
| ethylene diamine | | | | | |
| tetraacetic acid | | | | | |
| from BASF | | | | | |
| Saccharin from | 1.6 | 1.6 | 1.6 | 1.6 | 1.6 |
| Univar | | | | | |
| Pigments from | 0.045 | 0.045 | 0.045 | 0.045 | 0.045 |
| Camida | | | | | |
| Additives from | 1 | 1 | 1 | 1 | 1 |
| BASF, Sigma | | | | | |
| Aldhric | | | | | |
| N,N-Diethyl-p- | 0.84 | 0.00 | 0.00 | 0.00 | 0.00 |
| toluide (DE-p-T)/ | | | | | |
| N,N-Diethyl-o- | | | | | |
| toluide (DE-o-T) | | | | | |
| from Camida | | | | | |
| 1,2,3,4-tetrahydro | 0 | 0.50 | 0.50 | 0.50 | 0.50 |
| benzo(H) | | | | | |
| quinoline-3-ol | | | | | |
| (THBQ-ol) from | | | | | |
| Vanamali Organics | | | | | |
| Cumene | 3 | 0 | 0 | 0 | 0 |
| hydroperoxide | | | | | |
| (CHP) from | | | | | |
| Nouryon | | | | | |
| tert-butyl peroxy- | 0 | 0.25 | 0.5 | 0.75 | 1 |
| 3,5,5- | | | | | |
| triemthylhexanoate | | | | | |
| (TBPTH) from | | | | | |
| Arkema | | | | | |
| Total | 100.00 | 100.00 | 100.00 | 100.00 | 100.00 |

All four prepared formulations were tested for compressive shear strength, break torque, and prevail torque on mild steel and stainless steel. The bonded pin and collars and nut and bolts were allowed to cure at room temperature for 1 hour and 24 hours and the results were recorded and compared with the comparative formula. Further to understand the durability, mild steel pin and collars were bonded and cured at room temperature for 24 hrs and then exposed to 100° C. for 1000 hrs and compared to the strength performance of the control.

Compressive shear strength on mild steel and stainless steel, pins & collars (P&C) was measured according to ASTM D 4562-001.

Compressive shear strength of all four formulas is reported in Tables 2 and 3. Table 2 exemplify 1 hour room temperature cure compressive shear strength (Pin &Collar) N/mm² results and Table 3 exemplify 24-hour room temperature cure compressive shear strength (Pin &Collar) N/mm².

TABLE 2

Compressive shear strength, 1 hrs RTC, N/mm²

| Formulations | Mild Steel | Stainless Steel |
|---|---|---|
| Comparative | 10.9 | 3.5 |
| example 1 | | |
| Example 1 | 7.2 | 2.3 |
| Example 2 | 10 | 6.8 |
| Example 3 | 13.5 | 5 |
| Example 4 | 7.3 | 4.7 |

TABLE 3

Compressive shear strength, 24 hrs RTC, N/mm²

| Formulations | Mild Steel | Stainless Steel |
|---|---|---|
| Comparative | 12.0 | 5.8 |
| example 1 | | |
| Example 1 | 10.7 | 4.4 |
| Example 2 | 13.7 | 5.6 |
| Example 3 | 10.5 | 8.4 |
| Example 4 | 10.2 | 6.2 |

From above test results, it was observed that examples 2 and 3 exhibit similar 1 hour and 24-hour room temperature cure with similar compressive shear strengths on mild steel and stainless steel.

Break torque on mild steel and stainless steel, nuts & bolts (N&B) was measured according to ASTM D 5649-01.

Break torque of all four formulas is reported in Tables 4 and 5. Table 4 exemplifies 1 hour room temperature cure break torque (M10 N&B) Units N·m and table 5 exemplifies 24-hour room temperature cure break torque (M10 N&B) Units N·m.

TABLE 4

Break Torque, 1 hrs RTC, N · m

| Formulations | Mild steel | Stainless Steel |
|---|---|---|
| Comparative | 12 | 6 |
| example 1 | | |
| Example 1 | 19 | 4 |
| Example 2 | 10 | 5 |
| Example 3 | 13 | 7 |
| Example 4 | 10 | 9 |

TABLE 5

Break Torque, 24 hrs RTC, N · m

| Formulations | Mild Steel | Stainless Steel |
|---|---|---|
| Comparative | 12 | 6 |
| example 1 | | |
| Example 1 | 22 | 6 |
| Example 2 | 19 | 10 |
| Example 3 | 26 | 7 |
| Example 4 | 28 | 9 |

From above test results, all examples 1-4 show improvement in break torque on mild steel, whereas they are comparable on stainless steel.

Prevail torque on mild steel and stainless steel was measured according to ASTM D 5649-01.

Prevail torque of all four formulas are reported in Tables 6 and 7. Table 6 exemplifies 1 hour room temperature cure Prevail torque (N&B) Units N·m and table 7 exemplifies 24-hour room temperature cure Prevail torque (N&B) Units N·m.

TABLE 6

Prevail Torque, 1 hrs RTC, N · m

| Formulations | Mild Steel | Stainless Steel |
|---|---|---|
| Comparative | 30 | 8 |
| example 1 | | |
| Example 1 | 35 | 5 |
| Example 2 | 37 | 8 |
| Example 3 | 43 | 15 |
| Example 4 | 38 | 17 |

TABLE 7

Prevail Torque, 24 hrs RTC, N · m

| Formulations | Mild Steel | Stainless Steel |
|---|---|---|
| Comparative | 41 | 22 |
| example 1 | | |
| Example 1 | 44 | 22 |
| Example 2 | 48 | 22 |
| Example 3 | 43 | 23 |
| Example 4 | 43 | 21 |

From above test results, formulas Examples 5 6 showed an increase in 1 hour room temperature cure prevail torque on mild steel and stainless steel whereas 24-hour room temperature cure prevail torque is similar on mild steel and stainless steel when compared with comparative example.

### Heat Aging

All four formulas along with control were used to bond mild steel pin and collars and allowed to cure at room temperature for 24 hours and were then exposed to 100° C. for 1000 hours. After completion of 1000 hours at 100° C., the bonded pin and collar were allowed to cool to room temperature and tested for compressive shear strength to measure the retention in bond strength. The heat aging test was done according to ASTM D 4562-001.

Heat Aging compressive shear strength on mild steel (Pin &Collar) N/mm² test results are exemplified in table 8.

TABLE 8

| | Heat aging test, Mild steel, N/mm² | | |
|---|---|---|---|
| Formulations | Initial | final | % Retention |
| Comparative | 12 | 11.0 | 92.1 |
| example 1 | | | |
| Example 1 | 10.7 | 10 | 93.4 |
| Example 2 | 13.7 | 12.7 | 93.0 |
| Example 3 | 10.5 | 8.9 | 84.5 |
| Example 4 | 10.2 | 8.8 | 86.7 |

The heat aging results shows that, examples 1 and 2 show comparable retention in compressive share strength whereas examples 3 and 4 showed 9% drop in compressive shear strength when compare with control. Overall, all four examples show comparable retention in compressive shear strength with comparative example.

### Example 2

Four different formulations were prepared by keeping same concentration of common ingredients like methacrylate monomer (PEGDMA), stabilizers, chelators, and saccharin. The concentration of EtOH amine was maintained at 0.5% w/w and the tert-butyl peroxy-3,5,5-trimethylhexanoate (TBPTH) concentration was varied from 0.5, 1.0, 1.5 & 2.0% w/w in examples 5, 6, 7 and 8 respectively as shown in Table 9. The formulations with the new curatives are compared with comparative example 2 which contains the conventional curatives CHP (1.5%) and DE-p-T, DM-o-T (0.5%). All the components were mixed together for an appropriate time until fully dissolved.

TABLE 9

| | Comparative | Example | Example | Example | Example |
|---|---|---|---|---|---|
| Ingredients | example 2 | 5 | 6 | 7 | 8 |
| PEG200DMA from Geo | 93.46 | 94.46 | 93.96 | 93.46 | 92.96 |
| Specialty, Sartomer | | | | | |
| Saccharin from Univar | 2.40 | 2.40 | 2.40 | 2.40 | 2.40 |
| N,N-Dimethyl-o-toluide | 0.5 | — | — | — | — |
| (DM-o-T) and N,N- | | | | | |
| Diethyl-p-toluide (DE-p- | | | | | |
| T) from Camida | | | | | |
| 2-(N- | | 0.5 | 0.5 | 0.5 | 0.5 |
| ethylanilino)ethanol | | | | | |
| (EtOH amine) from | | | | | |
| BASF | | | | | |
| cumene hydroperoxide | 1.50 | — | — | — | — |
| (CPH) from Nouryon | | | | | |
| tert-butyl peroxy-3,5,5- | — | 0.50 | 1.00 | 1.50 | 2.00 |
| triemthylhexanoate | | | | | |
| (TBPTH) from Arkema | | | | | |
| 1,4-naphthoquinone | 0.21 | 0.21 | 0.21 | 0.21 | 0.21 |
| from Sigma Aldrich | | | | | |
| sodium salt of ethylene | 0.88 | 0.88 | 0.88 | 0.88 | 0.88 |
| diamine tetraacetic acid | | | | | |
| from BASF | | | | | |
| Pigments and additives | 1.05 | 1.05 | 1.05 | 1.05 | 1.05 |
| from Sigma Aldrich, | | | | | |
| Camida | | | | | |
| TOTAL | 100.0 | 100.0 | 100.0 | 100.0 | 100.0 |

### Shear Strength Performance

The above formulations were tested for shear strength, breakaway and prevail torque on active i.e., mild steel (MS) and inactive stainless-steel (SS) substrates after 1 Hr and 24 Hr curing at ambient temperature (2500). The substrates pins & collars used for shear strength testing were cleaned as per standard practice as per the standards five different specimens were bonded by each of the above formulations and tested for shear strength performance after 1 Hr and 24 Hr room temperature cure.

The shear strength performance was measured according to ASTM D 4562-001.

The results for comparative example 2, example 5, example 6, example 7 and example 8 were recorded on both the substrates after 1 h cure are shown in Table 2.

Table 10 exemplifies shear strength performance on mild steel and stainless-steel substrates after 1 h cure.

TABLE 10

| | Accelerator % w/w | | 1 h/Shear strength (N/mm²) | |
|---|---|---|---|---|
| | EtOH amine | TBPTH | Mild steel | Stainless steel |
| Comparative | 0.00 | 0.00 | 8.00 | 6.00 |
| example 2 | | | | |
| Example 5 | 0.50 | 0.50 | 11.00 | 5.00 |
| Example 6 | 0.50 | 1.00 | 12.00 | 5.00 |
| Example 7 | 0.50 | 1.50 | 10.00 | 5.00 |
| Example 8 | 0.50 | 2.00 | 11.00 | 4.00 |

The results obtained implies that the shear strength performance after 1 h cure for all the four examples 5-8 were comparable with comparative example 2.

In a similar way shear strength performance was tested after 24 h cure for all the examples on both the mild steel and stainless-steel substrates. The results are shown in Table 11.

TABLE 11

| | Accelerator % w/w | | 1 h/Shear strength (N/mm²) | |
|---|---|---|---|---|
| | EtOH amine | TBPTH | Mild steel | Stainless steel |
| Comparative | 0.00 | 0.00 | 9.90 | 7.30 |
| example 2 | | | | |
| Example 5 | 0.50 | 0.50 | 16.20 | 7.40 |
| Example 6 | 0.50 | 1.00 | 13.10 | 6.80 |
| Example 7 | 0.50 | 1.50 | 15.40 | 6.50 |
| Example 8 | 0.50 | 2.00 | 14.80 | 7.40 |

The shear strength performance of all the formulations after 24 h cure on mild steel and stainless-steel substrates are comparable with the control.

### Breakaway Torque Performance

The torque performance was measured after 1 h and 24 h cure on mild steel and stainless-steel substrates at room temperature. The initial torque gives the value of decreased axial load measurement and is termed as breakaway torque. The degreased five specimens of black oxide nut & bolts were assembled to evaluate the breakaway and prevail torque performance for comparative example 2 and examples 5-8 respectively.

The breakaway torque performance was measured according to ASTM D 5649-01.

Breakaway Torque was measured on mild steel and stainless-steel substrates after 1 h cure is as shown in Table 12.

TABLE 12

| | Accelerator % w/w | | 1 h/Break away torque (N · m) | |
|---|---|---|---|---|
| | EtOH amine | TBPTH | Mild steel | Stainless steel |
| Comparative | 0.00 | 0.00 | 8.00 | 3.00 |
| example 2 | | | | |
| Example 5 | 0.50 | 0.50 | 7.00 | 4.00 |
| Example 6 | 0.50 | 1.00 | 4.00 | 2.00 |
| Example 7 | 0.50 | 1.50 | 3.00 | 3.00 |
| Example 8 | 0.50 | 2.00 | 5.00 | 3.00 |

The breakaway torque results recorded for all the examples according to the present invention on mild steel and stainless-steel substrates after 1 h cure was observed to be comparable with comparative example 2.

Table 13 exemplify breakaway torque performance on mild steel and stainless-steel substrates after 24 h cure.

TABLE 13

| | Accelerator % w/w | | 1 h/Break away torque (N · m) | |
|---|---|---|---|---|
| | EtOH amine | TBPTH | Mild steel | Stainless steel |
| Comparative | 0.00 | 0.00 | 10.00 | 6.00 |
| example 2 | | | | |
| Example 5 | 0.50 | 0.50 | 14.00 | 8.00 |
| Example 6 | 0.50 | 1.00 | 10.00 | 10.00 |
| Example 7 | 0.50 | 1.50 | 13.00 | 9.00 |
| Example 8 | 0.50 | 2.00 | 10.00 | 10.00 |

In a similar way breakaway torque strength performance for all the formulations are observed to be comparable with comparative example 2 on both mild steel and stainless-steel substrates.

### Prevail Torque Performance

The prevail torque performance was measured by rotating the nuts 360° after initial breakage of the bond. The prevail torque performance of the formulations is recorded in Tables 14 and 15 below, and it was observed that examples according to the present invention show more or less similar performance to comparative example 2 on both the substrates mild steel and stainless-steel at room temperature after 1 h and 24 h curing.

The prevail torque performance was measured according to ASTM D 5649-01.

Table 14 exemplify prevail torque on mild steel and stainless-steel substrates after 1 h cure, whereas table 15 exemplify prevail torque on mild steel and stainless-steel substrates after 24 h cure.

TABLE 14

| | Accelerator % w/w | | 1 h/Prevail torque (N · m) | |
|---|---|---|---|---|
| | EtOH amine | TBPTH | Mild steel | Stainless steel |
| Comparative | 0.00 | 0.00 | 23.00 | 10.00 |
| example 2 | | | | |
| Example 5 | 0.50 | 0.50 | 21.00 | 17.00 |
| Example 6 | 0.50 | 1.00 | 23.00 | 14.00 |
| Example 7 | 0.50 | 1.50 | 21.00 | 15.00 |
| Example 8 | 0.50 | 2.00 | 24.00 | 13.00 |

TABLE 15

| | Accelerator % w/w | | 1 h/Prevail torque (N · m) | |
|---|---|---|---|---|
| | EtOH amine | TBPTH | Mild steel | Stainless steel |
| Comparative | 0.00 | 0.00 | 39.00 | 23.00 |
| example 2 | | | | |
| Example 5 | 0.50 | 0.50 | 36.00 | 23.00 |
| Example 6 | 0.50 | 1.00 | 45.00 | 34.00 |
| Example 7 | 0.50 | 1.50 | 42.00 | 24.00 |
| Example 8 | 0.50 | 2.00 | 38.00 | 22.00 |

### Heat Aging Performance

The heat aging shear strength performance was evaluated after curing 24 h and aging at 100° C. for 1000 h. After heat treatment, the pins and collars were allowed to cool to room temperature and tested for shear strength. The results obtained show that, strength performance for the examples according to the present invention are comparable with comparative example 2 as exemplified in table 16.

The heat aging test was done according to ASTM D 4562-001.

TABLE 16

| | | | Shear strength at |
|---|---|---|---|
| | | | 100° C. after 1000 h |
| | Accelerator % w/w | | (N/mm²) |
| | EtOH amine | TBPTH | Mild steel |
| Comparative | 0.00 | 0.00 | 12.00 |
| example 2 | | | |
| Example 5 | 0.50 | 0.50 | 12.00 |
| Example 6 | 0.50 | 1.00 | 14.00 |
| Example 7 | 0.50 | 1.50 | 13.00 |
| Example 8 | 0.50 | 2.00 | 13.00 |

1. An anaerobic curable composition comprising
a) a (meth) acrylate component;
b) a first curing agent;
c) a second curing agent; and
d) a cure accelerator comprising 2-(N-ethylanilino)ethanol and/or 1,2,3,4-tetrahydro benzo(H) quinoline-3-ol.

2. An anaerobic curable composition according to claim 1, wherein the (meth)acrylic monomer is present from 87 to 97% by weight of the total weight of the composition.

3. An anaerobic curable composition according to claim 1, wherein the first curing agent is a hydroperoxide selected from the group consisting of t-butyl hydroperoxide, p-methane hydroperoxide, tert-butyl perbenzoate, diisopropylbenzene hydroperoxide, tert-butyl peroxy-3,5,5-trimethylhexanoate, diacetyl peroxide, benzoyl peroxide, tert-butyl peracetate, lauryl peroxide, tert-butyl peroxybenzoate, tert-butylperoxy-2-ethylhexyl carbonate, tert-amyl hydroperoxide, 1,1,3,3-tetramethyl butyl hydroperoxide, and mixtures thereof.

4. An anaerobic curable composition according to claim 1, wherein the first curing agent is present from 0.1 to 3.0% by weight of the total weight of the composition.

5. An anaerobic curable composition according to claim 1, wherein the second curing agent is selected from the group consisting of saccharin, di-p-toluylsulfonimide, tert-butylbenzoyl toluylsulfonamide, methylbenzoyl toluylsulfonamide, methoxybenzoyl toluylsulfonamide, and mixtures thereof.

6. An anaerobic curable composition according to claim 1, wherein the second curing agent is present from 0.1 to 5.0% by weight of the total weight of the composition.

7. An anaerobic curable composition according to claim 1, wherein the cure accelerator is present from 0.1 to 1.5% by weight of the total weight of the composition.

8. An anaerobic curable composition comprising according to claim 1, comprising
a) a (meth) acrylate component;
b) a first curing agent, wherein the first curing agent is tert-butyl peroxy-3,5,5-trimethylhexanoate;
c) a second curing agent; and
d) a cure accelerator comprising 2-(N-ethylanilino)ethanol and/or 1,2,3,4-tetrahydro benzo(H) quinoline-3-ol.

9. An anaerobic curable composition according to claim 8, wherein the tert-butyl peroxy-3,5,5-trimethyl hexanoate is present from 0.1 to 3.0% by weight of the total weight of the composition, and
2-(N-ethylanilino)ethanol is present from 0.1 to 1.5% by weight of the total weight of the composition
and/or
1,2,3,4-tetrahydro benzo(H) quinoline-3-ol is present from 0.1 to 1.5% by weight of the total weight of the composition.

10. An anaerobic curable composition according to claim 1, wherein the composition further comprises a stabilizer selected from the group consisting of benzoquinone, 1,4-naphthoquinone, anthraquinone, hydroquinone, methoxyhydroquinone, tert-butylhydroquinone butylated hydroxy toluene, and mixtures thereof.

11. An anaerobic curable composition according to claim 10, wherein the stabilizer is present from 0.01 to 1.0% by weight of the total weight of the composition.

12. An anaerobic curable composition according to claim 1, wherein the composition further comprises a chelating agent selected from the group consisting of sodium salt of ethylene diamine tetraacetic acid, N-hydroxy ethylenediamine tetra acetic acid trisodium salt, tetrakis-(2-hydroxy propyl) ethylene diamine, diethylenetriaminepentaacetic acid pentasodium salt, and mixtures thereof.

13. An anaerobic curable composition according to claim 12, wherein the chelating agent is present from 0.2 to 2.0% by weight of the total weight of the composition.

14. A cured product of the anaerobic curable composition according to claim 1.
